(19) United States
(12) Patent Application Publication
(10) Pub. No.: US 2023/0011639 A1
(43) Pub. Date: Jan. 12, 2023

(54) SYSTEM AND METHOD FOR CONTROLLING TEMPERATURE IN A THREE-DIMENSIONAL (3D) PRINTER

(71) Applicant: XEROX CORPORATION, Norwalk, CT (US)

(72) Inventors: Jason M. LeFevre, Penfield, NY (US); Joseph C. Sheflin, Macedon, NY (US); Palghat S. Ramesh, Pittsford, NY (US)

(73) Assignee: XEROX CORPORATION, NORWALK, CT (US)

(21) Appl. No.: 17/371,470

(22) Filed: Jul. 9, 2021

(51) Int. Cl. B22F 10/34; B22F 10/22; B22F 12/13; B22F 12/17; B22F 12/33; B22F 12/53; B22F 12/70; B33Y 30/00; B33Y 40/10; B33Y 70/00

(52) U.S. Cl. CPC B22F 10/34; B22F 10/22; B22F 12/13; B22F 12/17; B22F 12/33; B22F 12/53; B22F 12/70; B33Y 30/00; B33Y 40/10; B33Y 70/00; B22F 2201/10; B22F 2203/11; B22F 2301/052

(57) ABSTRACT

A printer includes a heat control device configured to cause a temperature of a part that is printed by the printer to remain within a predetermined range as a height of the part increases from about 0 mm to about 30 mm. The predetermined range is from about 545° C. to about 600° C. The heat control device includes a heat plate that is configured to generate heat in a downward direction toward the part.

### TECHNICAL FIELD

The present teachings relate generally to three-dimensional (3D) printing and, more particularly, to systems and methods for controlling the temperature of a 3D part being printed by the 3D printer.

### BACKGROUND

A 3D printer builds (e.g., prints) a 3D part from a computer-aided design (CAD) model, usually by successively depositing material layer upon layer. For example, a first layer may be deposited upon a build plate, and then a second layer may be deposited upon the first layer. One particular type of 3D printer is a magnetohydrodynamic (MHD) printer, which is suitable for depositing liquid metal layer upon layer to form a 3D metallic object. Magnetohydrodynamic refers to the study of the magnetic properties and the behavior of electrically conducting fluids. In a MEM printer, an electrical current flows through a metal coil, which produces time-varying magnetic fields that induce eddy currents within a reservoir of liquid metal compositions. Coupling between magnetic and electric fields within the liquid metal results in Lorentz forces that cause drops of the liquid metal to be ejected (also referred to as jetted) through a nozzle of the printer. The drops land upon the build plate and/or the previously deposited drops to cause the 3D part to grow in size.

The build plate may be heated, which delivers heat to the 3D part as it is being printed. As the 3D part grows taller, the upper surface of the 3D part becomes farther away from the heated build plate, which may cause the upper surface of the 3D part to cool faster than lower layers of the 3D part. The properties of the 3D part may depend at least partially upon the temperature of the 3D part during the printing process. More particularly, the properties of the 3D part may depend at least partially upon the different layers of the 3D part being exposed to substantially the same temperature during the printing process. Therefore, what is needed is an improved system and method for controlling the temperature of the 3D part during the printing process.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A printer configured to print a part is disclosed. The printer includes a heat control device configured to prevent a temperature of the part from decreasing by more than about 5° C. as a height of the part increases from about 0 mm to about 30 mm. The heat control device includes a gas curtain source that is configured to generate a gas curtain that at least partially surrounds at least a portion of the part.

A 3D printer is also disclosed. The 3D printer includes a pump having a nozzle. The nozzle is configured to jet a plurality of drops therethrough. The drops include liquid metal. The 3D printer also includes a build plate configured to have the drops land thereon and solidify to form a 3D part. The 3D printer also includes a heat control device configured to prevent a temperature of a top surface of the 3D part from decreasing by more than about 20° C. as a distance between the build plate and the top surface of the 3D part increases from about 0 mm to about 50 mm. The heat control device includes a gas curtain source that is configured to direct a gas curtain in a substantially downward direction. The gas curtain at least partially surrounds the drops as the drops descend from the nozzle toward the build plate and the 3D part on the build plate. The gas curtain has a temperature from about 60° C. to about 150° C.

In another embodiment, the 3D printer includes a pump having a nozzle. The 3D printer also includes a heating element configured to heat a solid metal within the pump, thereby converting the solid metal to a liquid metal. The solid metal and the liquid metal include aluminum. The 3D printer also includes a coil wrapped at least partially around the pump. The 3D printer also includes a power source configured to transmit voltage pulses to the coil. The coil causes a plurality of drops of the liquid metal to be jetted through the nozzle in response to the voltage pulses. The drops have a temperature from about 550° C. to about 950° C. The 3D printer also includes a shield gas source configured to introduce a shield gas at least partially around the nozzle, the drops, or both. The 3D printer also includes a build plate configured to have the drops land thereon and solidify to form a 3D part. The build plate includes a build plate heater that is configured to have a temperature from about 350° C. to about 750° C., which generates heat in an upward direction. The 3D printer also includes a heat control device that includes a gas curtain source positioned above the build plate. The gas curtain source is configured to direct a gas curtain in a substantially downward direction. The gas curtain at least partially surrounds the build plate, the drops as the drops descend from the nozzle toward the build plate, and the 3D part on the build plate. The gas curtain has a temperature from about 80° C. to about 120° C. The heat control device is configured to prevent a temperature of a top surface of the 3D part from decreasing by more than about 60° C. as a distance between the build plate and the top surface of the 3D part increases from about 0 mm to about 100 mm. The heat control device is also configured to cause the temperature of the top surface of the 3D part to remain within a predetermined range as the distance between the build plate and the top surface of the 3D part increases from about 0 mm to about 100 mm. The predetermined range is from about 490° C. to about 600° C.

In another embodiment, a printer is disclosed that is configured to print a part. The printer includes a heat control device configured to cause a temperature of the part to remain within a predetermined range as a height of the part increases from about 0 mm to about 30 mm. The predetermined range is from about 545° C. to about 600° C. The heat control device includes a heat plate that is configured to generate heat in a downward direction toward the part.

In another embodiment, the 3D printer includes a pump having a nozzle. The nozzle is configured to jet a plurality of drops therethrough. The drops include liquid metal. The 3D printer also includes a build plate configured to have the drops land thereon and solidify to form a 3D part. The 3D printer also includes a heat control device configured to cause a temperature of a top surface of the 3D part to remain within a predetermined range as a distance between the build plate and the top surface of the 3D part increases from about 0 mm to about 50 mm. The predetermined range is from about 530° C. to about 600° C. The heat control device includes a heat plate positioned above the build plate. The heat plate has an opening through which the nozzle extends, the drops descend, or both. The heat plate is configured to have a temperature from about 475° C. to about 675° C., which generates heat in a downward direction toward the 3D part.

In another embodiment, the 3D printer includes a pump having a nozzle. The 3D printer also includes a heating element configured to heat a solid metal within the pump, thereby converting the solid metal to a liquid metal. The solid metal and the liquid metal include aluminum. The 3D printer also includes a coil wrapped at least partially around the pump. The 3D printer also includes a power source configured to transmit voltage pulses to the coil. The coil causes a plurality of drops of the liquid metal to be jetted through the nozzle in response to the voltage pulses. The drops have a temperature from about 550° C. to about 950° C. The 3D printer also includes a shield gas source configured to introduce a shield gas at least partially around the nozzle, the drops, or both. The 3D printer also includes a build plate configured to have the drops land thereon and solidify to form a 3D part. The build plate includes a build plate heater that is configured to have a temperature from about 350° C. to about 750° C., which generates heat in an upward direction. The 3D printer also includes a heat control device that includes a heat plate positioned above the build plate. The heat plate has an opening through which the nozzle extends, the drops descend, or both. The heat plate is configured to have a temperature from about 525° C. to about 625° C., which generates heat in a downward direction toward the 3D part. The heat control device is configured to prevent a temperature of a top surface of the 3D part from decreasing by more than about 60° C. as a distance between the build plate and the top surface of the 3D part increases from about 0 mm to about 100 mm. The heat control device is also configured to cause the temperature of the top surface of the 3D part to remain within a predetermined range as the distance between the build plate and the top surface of the 3D part increases from about 0 mm to about 100 mm. The predetermined range is from about 490° C. to about 600° C.

In another embodiment, a 3D printer is disclosed. The 3D printer is configured to print a 3D part using a metallic printing material. The 3D printer includes a heat control device configured to prevent a temperature of the 3D part from decreasing by more than about 5° C. as a height of the 3D part increases from about 0 mm to about 30 mm.

In another embodiment, a 3D printer is disclosed. The 3D printer includes a pump having a nozzle. The nozzle is configured to jet a plurality of drops therethrough. The drops include liquid aluminum. The 3D printer also includes a build plate configured to have the drops land thereon and solidify to form a 3D part. The 3D printer also includes a heat control device configured to prevent a temperature of a top surface of the 3D part from decreasing by more than about 20° C. as a distance between the build plate and the top surface of the 3D part increases from about 0 mm to about 50 mm. The heat control device is also configured to cause the temperature of the top surface of the 3D part to remain within a predetermined range as the distance between the build plate and the top surface of the 3D part increases from about 0 mm to about 50 mm. The predetermined range is from about 530° C. to about 600° C.

In another embodiment, a 3D printer is disclosed. The 3D printer includes a pump having a nozzle. The 3D printer also includes a heating element configured to heat a solid metal within the pump, thereby converting the solid metal to a liquid metal. The solid metal and the liquid metal include Aluminum Association (AA) 6061 aluminum. The 3D printer also includes a coil wrapped at least partially around the pump. The 3D printer also includes a power source configured to transmit voltage pulses to the coil. The coil causes a plurality of drops of the liquid metal to be jetted through the nozzle in response to the voltage pulses. The drops have a temperature from about 550° C. to about 950° C. The 3D printer also includes a shield gas source configured to introduce a shield gas at least partially around the nozzle, the drops, or both. The 3D printer also includes a build plate configured to have the drops land thereon and solidify to form a 3D part. The build plate includes a build plate heater that is configured to have a temperature from about 350° C. to about 750° C., which generates heat in an upward direction. The 3D printer also includes a heat control device having a gas curtain source positioned above the build plate. The gas curtain source is configured to direct a gas curtain in a downward direction. The gas curtain at least partially surrounds the build plate, the drops as the drops descend from the nozzle toward the build plate, and the 3D part on the build plate. The gas curtain has a temperature from about 80° C. to about 120° C. The heat control device also includes a heat plate positioned above the build plate. The heat plate has an opening through which the nozzle extends, the drops descend, or both. The heat plate is configured to have a temperature from about 525° C. to about 625° C., which generates heat in the downward direction. The heat control device is configured to prevent a temperature of a top surface of the 3D part from decreasing by more than about 60° C. as a distance between the build plate and the top surface of the 3D part increases from about 0 mm to about 100 mm. The heat control device is also configured to cause the temperature of the top surface of the 3D part to remain within a predetermined range as the distance between the build plate and the top surface of the 3D part increases from about 0 mm to about 100 mm. The predetermined range is from about 490° C. to about 600° C.

A method is also disclosed. The method includes jetting a plurality of drops through a nozzle of a printer to form a part. The method also includes controlling a temperature of the part using a heat control device. Controlling the temperature includes preventing a temperature of the part from decreasing by more than about 5° C. as a height of the part increases from about 0 mm to about 30 mm.

In another embodiment, the method includes jetting a plurality of drops through a nozzle of a printer onto a build plate to form a part. The method also includes controlling a temperature of a top surface of the part using a heat control device. Controlling the temperature includes preventing a temperature of the top surface of the part from decreasing by more than about 20° C. as a distance between the build plate and the top surface of the part increases from about 0 mm to about 50 mm. Controlling the temperature also includes causing the temperature of the top surface of the part to remain within a predetermined range as the distance between the build plate and the top surface of the part increases from about 0 mm to about 50 mm. The predetermined range is from about 530° C. to about 600° C.

In another embodiment, the method includes jetting a plurality of drops through a nozzle of a printer onto a build plate to form a part. The part includes a plurality of layers that are vertically-stacked. The method also includes controlling a temperature of a top surface of the part using a heat control device. Controlling the temperature includes directing a gas curtain in a downward direction. The gas curtain at least partially surrounds the build plate, the drops as the drops descend from the nozzle toward the build plate, and the part on the build plate. The gas curtain has a temperature from about 80° C. to about 120° C. Controlling the temperature also includes generating heat in a downward direction using a heat plate that is positioned above the build plate. The heat plate has an opening through which the nozzle extends, the drops descend, or both. The heat plate is configured to have a temperature from about 525° C. to about 625° C., which generates heat in the downward direction. The heat control device is configured to prevent a temperature of the top surface of the part from decreasing by more than about 60° C. as a distance between the build plate and the top surface of the part increases from about 0 mm to about 100 mm. The heat control device is also configured to cause the temperature of the top surface of the part to remain within a predetermined range as the distance between the build plate and the top surface of the part increases from about 0 mm to about 100 mm. The predetermined range is from about 490° C. to about 600° C.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 depicts a schematic cross-sectional view of a 3D printer, according to an embodiment.

FIGS. 2A and 2B depict graphs showing drop control and drop bonding as a function of temperature for two different printing materials, according to an embodiment.

FIG. 3 depicts a schematic side view of a portion of the 3D printer including a first example of a heat control device (e.g., a gas curtain source), according to an embodiment.

FIG. 4 depicts a schematic top view of a portion of the 3D printer including the heat control device, according to an embodiment.

FIG. 5 depicts a schematic side view of a portion of the 3D printer including a second example of the heat control device (e.g., a heat plate), according to an embodiment.

FIG. 6 depicts a graph showing the height of the 3D part versus the temperature inside the gas curtain, according to an embodiment.

FIG. 7 depicts a schematic top view of the build volume (e.g., inside of the gas curtain), according to an embodiment.

FIG. 8 depicts a graph showing the height of the 3D part versus the temperature of the (e.g., top) surface of the 3D part, according to an embodiment.

FIG. 9 depicts a flowchart of a method for printing the 3D part, according to an embodiment.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

The systems and methods disclosed herein are directed to a three-dimensional (3D) printer. The 3D printer may be or include a drop-on-demand printer that is configured to print (i.e., build) a 3D part. As described in greater detail below, the 3D printer may use a magnetohydrodynamic (MHD) process to jet small drops of liquid material (e.g., metal) in response to firing pulses. Using this technology, the 3D part can be created from the material by ejecting a series of drops which bond together.

Metal ejected from the 3D printer may be deposited onto a heated build plate. Delivering target part surface temperature (i.e., controlling the temperature of the surface(s) of the 3D part) throughout the entirety of the printing process may help to yield target physical properties (tensile strength, elongation, etc.) as well as maintain continuity of part “build-rules” for part shape integrity. For some aluminum alloys (e.g., Aluminum Association (AA) 4008 aluminum), a build plate temperature range (“sweet spot”) exists that can accommodate the desired drop bonding aspects as well as the drop control aspects that deliver acceptable part quality.

Due to the acceptable range of part surface temperatures identified for AA 4008, the reduction in part surface temperature as the part builds higher and away from the heated build plate (e.g., up to 150 mm tall) stays within the “range” and does not inhibit the ability to deliver target material strength properties and shape integrity.

The systems and methods described herein use two different techniques for adding to and maintaining the temperature immediately around the area of the 3D part for the purpose of maintaining the top surface temperature within a predetermined range. In one embodiment, a gas curtain may be arranged around the perimeter of the build area. The gas curtain may be positioned such that the heated build plate can move in a substantially horizontal plane and still remain within the gas curtain. In another embodiment, a heat plate may be installed on the underside of the print-head mounting structure. The heat plate may have an opening in it, such that the drops can be jetted therethrough while also maintaining the current printhead gap. A combination of these two embodiments has shown to be effective in reducing heat loss on/around the 3D part (e.g., when the 3D part is made using AA 6061), so that the top surface temperature 3D part can be maintained.

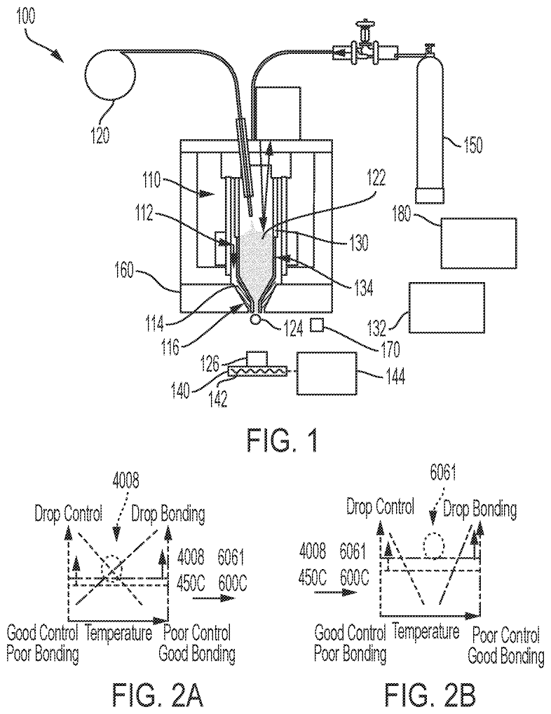

FIG. 1 depicts a schematic cross-sectional view of a 3D printer 100, according to an embodiment. The 3D printer 100 may include pump (also referred to as a pump chamber or ejector) 110. The pump 110 may include a first (e.g., upper) portion 112 and a second (e.g., lower) portion 114. The lower portion 114 may be or include a nozzle 116.

The pump 110 may define an inner volume that is configured to receive a printing material 120. The printing material 120 may be or include a metal, a polymer (e.g., a photopolymer), or the like. For example, the printing material 120 may be or include aluminum (e.g., a spool of aluminum wire). The aluminum may be AA 4008, AA 6061, AA 7075, or the like. In another embodiment, the printing material 120 may be or include copper.

The 3D printer 100 may also include one or more heating elements 130. The heating elements 130 are configured to melt the printing material 120 within the inner volume of the pump 110, thereby converting the printing material 120 from a solid material to a liquid material (e.g., liquid metal) 122 within the inner volume of the pump 110.

The 3D printer 100 may also include a power source 132 and one or more metallic coils 134. The metallic coils 134 are wrapped at least partially around the pump 110 and/or the heating elements 130. The power source 132 may be coupled to the coils 134 and configured to provide power thereto. In one embodiment, the power source 132 may be configured to provide a step function direct current (DC) voltage profile (e.g., voltage pulses) to the coils 134, which may create an increasing magnetic field. The increasing magnetic field may cause an electromotive force within the pump 110, that in turn causes an induced electrical current in the liquid metal 122. The magnetic field and the induced electrical current in the liquid metal 122 may create a radially inward force on the liquid metal 122, known as a Lorenz force. The Lorenz force creates a pressure at an inlet of the nozzle 116 of the pump 110. The pressure causes the liquid metal 122 to be jetted through the nozzle 116 in the form of one or more drops 124.

As the drops 124 are jetted, and new printing material 120 is fed into the pump 110, dross may accumulate in the pump 110 (e.g., in the upper portion 112). As used herein, “dross” refers to oxides and/or other contaminants. The build-up of dross may be a function of the total throughput of printing material 120 through the pump 110. As the dross builds within the pump 110, it may clog the pump 110. The dross may be removed (e.g., using a vacuum).

The 3D printer 100 may also include a build plate (also referred to as a build surface or substrate) 140 that is positioned below the nozzle 116. The drops 124 that are jetted through the nozzle 116 may land upon the build plate 140 and cool and solidify to produce a 3D part 126. The build plate 140 may include a heater 142 therein that is configured to increase the temperature of the build plate 140 and the 3D part 126 thereon. As mentioned above, as the height of the 3D part 126 increases, the upper surface of the 3D part 126 becomes farther from the heated build plate 140, which may cause the upper surface of the 3D part 126 to cool faster as the 3D part 126 grows taller.

The 3D printer 100 may also include a build plate control motor 144 that is configured to move the build plate 140 as the drops 124 are being jetted (i.e., during the printing process) to cause the 3D part 126 to have the desired shape and size. The build plate control motor 144 may be configured to move the build plate 140 in one dimension (e.g., along an X axis), in two dimensions (e.g., along the X axis and a Y axis), or in three dimensions (e.g., along the X axis, the Y axis, and a Z axis). As used herein, the X and Y axes are in a horizontal plane, and the Z axis is vertical. In another embodiment, the pump 110 and/or the nozzle 116 may also or instead be configured to move in one, two, or three dimensions.

The 3D printer 100 may also include one or more shield gas sources (one is shown: 150). The shield gas source 150 may be configured to introduce a shield gas that at least partially surrounds the nozzle 116, the drops 124, the 3D part 126, or a combination thereof. The shield gas may be or include an inert gas such as argon. The shield gas may reduce oxidization as the drops 124 are falling to the build plate 140.

The 3D printer 100 may also include a heat control device 160. The heat control device 160 may be configured to at least partially isolate the environment proximate to the 3D part 126 from the environment distal from the 3D part 126. More particularly, the heat control device 160 may help to reduce the amount of heat (e.g., from the printing process) that escapes from the environment inside of a build volume to the environment outside of the build volume. This, in turn, may reduce the amount by which the temperature of the (e.g., top) surface of the 3D part 126 decreases as the height of the 3D part 126 increases. This is described in greater detail below.

The 3D printer 100 may also include a temperature sensor 170 that is configured to measure a temperature inside and/or outside of the build volume. The temperature sensor 170 may be configured to measure the temperature of (or around) the 3D part 126. For example, the temperature sensor 170 may be configured to measure the temperature of (or around) the upper surface/layer of the 3D part 126 as the 3D part 126 increases in height.

The 3D printer 100 may also include a computing system 180. The computing system 180 may be configured to control the printing process. More particularly, the computing system 180 may be configured to control the pump 110, the introduction of the printing material 120, the heating elements 130, the power source 132, the build plate 140, the heater 142, the control motor 144, the shield gas sources 150, the heat control device 160, the temperature sensor 170, or a combination thereof.

FIGS. 2A and 2B depict graphs showing drop control and drop bonding as a function of temperature for two different printing materials, according to an embodiment. More particularly, the graph in FIG. 2A shows drop control and drop bonding as a function of temperature for a first printing material, and the graph in FIG. 2B shows drop control and drop bonding as a function of temperature for a second printing material. As used herein, “drop control” refers to the ability of the drop 124 to land in a designated location and remain in that location while maintaining the shape integrity of the 3D part 126, and “drop bonding” refers to the ability for the drop 124 to adequately bond to the 3D part 126 so that material strength goals are achieved.

The first and second printing materials may both be metals. More particularly, the first and second printing materials may both be or include aluminum or aluminum alloys. For example, the first printing material may be or include AA 4008, and the second printing material may be or include AA 6061. The first and second printing materials may have different chemistry and/or physical properties. For example, the primary alloying element in the first printing material may be magnesium, and the primary alloying element in the second printing material may be silicon. The first and second printing materials may also have different melt temperatures, different liquidous temperatures, different solidus temperatures, or a combination thereof.

For some aluminum alloys (e.g., AA 4008), a temperature range (i.e., “a sweet spot”) of the build plate 140 has been identified that can accommodate the desired drop bonding aspects and the drop control aspects to deliver acceptable part quality. Consequently, because of the acceptable range of surface temperatures for the 3D part 126 built using the first printing material (e.g., AA 4008), the reduction in the surface temperature of the 3D part 126 as the 3D part 126 builds higher (e.g., up to 150 mm) stays within the range and does not inhibit the ability to deliver target material strength properties and shape integrity.

The second printing material (e.g., ASM 6061) does not have the same build plate temperature latitude as the first printing material. In fact, there is negative latitude space when it comes to the build process for the second printing material given the build plate design and reduction in top surface part temperature as the part height increases. As used herein, “negative latitude space” refers to the inability for a system to work within a set of known constraints to arrive at a desired level of performance.

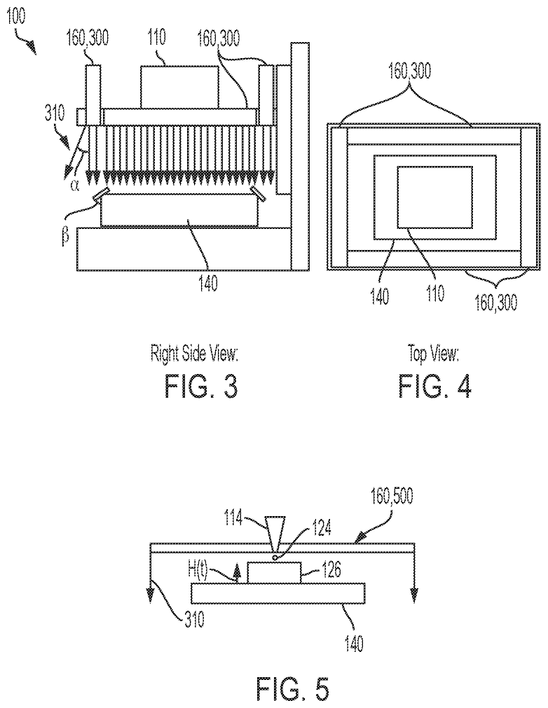

FIG. 3 depicts a schematic side view of a portion of the 3D printer 100 including a first example of the heat control device 160, according to an embodiment. In the embodiment shown in FIG. 3, the heat control device 160 may be or include a gas curtain source 300 that is configured to introduce/generate a gas curtain 310 at least partially around the build plate 140, the drops 124, the 3D part 126, or a combination thereof. The gas curtain source 300 may also or instead introduce the gas curtain 310 at least partially around the current printing location (e.g., where the drops 124 land), even if the gas curtain 310 does not surround the entire 3D part 126. In one embodiment, the build volume may be vertically between the nozzle 116 and the build plate 140, and laterally within the walls of the gas curtain 310.

The gas curtain 310 may serve to at least partially isolate the environment inside of the gas curtain 310 (e.g., the build volume) from the environment outside of the gas curtain 310. More particularly, the gas curtain 310 may help to prevent the heat (e.g., from the printing process) from escaping from the environment inside of the gas curtain 310 to the environment outside of the gas curtain 310. The gas curtain 310 may also or instead help to maintain a substantially uniform temperature in the environment inside of the gas curtain 310, so that the temperature of the upper surface of the 3D part 126 remains substantially the same as the 3D part 126 increases in height. The temperature inside of the gas curtain 310 may be from about 100° C. to about 600° C., about 400° C. to about 600° C., or about 450° C. to about 600° C. The ambient temperature (e.g., outside of the gas curtain 310) may be from about 15° C. to about 40° C., about 20° C. to about 35° C., or about 25° C. to about 30° C. The gas curtain 310 may be or include air. In another embodiment, the gas curtain 310 may be or include an inert gas such as argon. The gas curtain 310 may at least partially surround the shield gas.

The gas curtain 310 may be directed substantially vertically (e.g., downward). In one embodiment, the gas curtain source 300 may direct at least a portion of the gas curtain 310 downward and slightly outward (e.g., from the nozzle 116, 3D part 126, and/or build plate 140) at an angle a from about 5° to about 30° with respect to vertical. As a result, at least a portion of the gas curtain 310 may be in the shape of an inverted cone. In another embodiment, the printer 100 may include a gas curtain surface 320 that is positioned below the gas curtain source 300. The gas curtain surface 320 may be the build plate 140 or may be positioned at least partially around the build plate 140. The gas curtain surface 320 may be oriented at an angle β with respect to horizontal. The angle β may be from about 5° to about 30°. Thus, at least a portion of the gas curtain surface 320 may be in the shape of an inverted cone. Either or both of these embodiments may direct the gas curtain 310 away from the 3D part 126 (as opposed to toward the 3D part 126) so that the gas curtain 310 does not “blow on” the 3D part 126 during printing, which may affect the temperature and/or solidification of the 3D part 126.

FIG. 4 depicts a schematic top view of a portion of the 3D printer 100 including the gas curtain 310, according to an embodiment. As may be seen, the gas curtain source 300 and/or the gas curtain 310 may be positioned at least partially around the pump 110, the nozzle 116, the build plate 140, or a combination thereof. For example, in the embodiment shown, the gas curtain 310 has four walls that form a rectangle. In other embodiments, the gas curtain 310 may include more or fewer walls. For example, the gas curtain 310 may include three walls, and the fourth wall may be structural (e.g., granite). As mentioned above, the build plate 140 may be configured to move in the horizontal plane while the drops 124 are jetted and the 3D part 126 is being printed. The perimeter of the gas curtain 310 may be sized and positioned such that the build plate 140 remains within the gas curtain 310 even when the build plate 140 moves.

FIG. 5 depicts a schematic side view of a portion of the 3D printer 100 including a second example of the heat control device 160, according to an embodiment. The heat control device 160 may also or instead include a heat plate 500. The heat plate 500 may be used instead of, or in addition to, the gas curtain source 300 and/or the gas curtain 310. The heat plate 500 may be positioned on the underside of the print-head mounting structure. For example, the heat plate 500 may be positioned below the pump 110. The heat plate 500 may be at least partially horizontally aligned with the nozzle 116. The heat plate 500 may have an opening in it through which the nozzle 116 may extend and/or the drops 124 may pass. This may help to maintain the current printhead gap. The heat plate 500 may be positioned above the 3D part 126 and/or the build plate 140. In one embodiment, the build volume may be defined vertically between the heat plate 500 and the build plate 140. The build volume may also be defined laterally within the perimeter of the heat plate 500, laterally within the perimeter of the build plate 140, and/or laterally within the perimeter of the gas curtain 310.

A distance between the heat plate 500 and the top surface of the 3D part 126 may remain substantially constant as a distance between the build plate 140 and the top surface to the 3D part 126 increases. The distance between the heat plate 500 and the top surface of the 3D part 126 may be substantially the same as a distance between the nozzle 116 and the top surface of the 3D part 126. A lower surface of the heat plate 500 may have a greater surface are than the upper surface of the build plate 140. As a result, when the build plate motor 144 moves the build plate 140 in a horizontal plane, the build plate 140 may remain below the heat plate 500 and positioned within a perimeter of the heat plate 500.

The temperature of the drops 124 may be from about 550° C. to about 950° C., about 650° C. to about 850° C., or about 700° C. to about 800° C. The temperature of the build plate 140 may be from about 350° C. to about 750° C., about 450° C. to about 650° C., or about 500° C. to about 600° C. The temperature of the heat plate 500 may be from about 375° C. to about 775° C., about 475° C. to about 675° C., or about 525° C. to about 625° C. The temperature of the gas curtain 310 may be from about 40° C. to about 200° C., about 60° C. to about 150° C., or about 80° C. to about 120° C. The mass of the drops 124 may be from about 0.5 g/10 k to about 10 g/10 k, about 1.0 g/10 k to about 5 g/10 k, or about 1.25 g/10 k to about 1.75 g/10 k. The frequency at which the drops 124 are jetted through the nozzle 116 may be from about 100 Hz to about 500 Hz, about 200 Hz to about 400 Hz, or about 250 Hz to about 350 Hz. The spacing of the drops 124 (e.g., on the build plate 140 or the 3D part 126) may be from about 0.1 mm to about 2 mm, about 0.2 mm to about 1.0 mm, or about 0.4 mm to about 0.6 mm. The line spacing may be from about 0.1 mm to about 2 mm, about 0.2 mm to about 1.0 mm, or about 0.35 mm to about 0.55 mm. The build material may be aluminum (e.g., AA 6061). The ambient heat transfer coefficient of may be from about 1 W/mm²-degK to about 20 W/mm²-degK, about 5 W/mm²-degK to about 15 W/mm²-degK, or about 8 W/mm²-degK to about 12 W/mm²-degK. The emissivity of the build plate 140 may be from about 0.1 to about 0.5, about 0.15 to about 0.4, or about 0.2 to about 0.3. The ambient temperature (e.g., outside of the gas curtain 310) may be from about 15° C. to about 45° C., about 20° C. to about 40° C., or about 25° C. to about 35° C.

Iterations of the model may be performed through a range of build-height conditions (i.e., the height of the 3D part 126), and the build area overall air temperature may decrease as the build height of the 3D part 126 increases. The effect of the heat plate 500 on the z-height temperature may depend at least partially upon the ambient temperature of the build volume due to the heat plate 500 and its distance from the build plate 140. The effect of the heat plate 500 on the z-height temperature may also depend at least partially upon the radiant heating of the upper surface of the 3D part 126 from the heat plate 500. As used herein, the term “z-height temperature” refers to the temperature of the upper surface of the 3D part 126 as a function of the height of the 3D part 126 and/or as a function of the distance away from the heated build plate 140.

When the gas curtain 310 is used in combination with the heat plate 500, the gas curtain 310 may keep the heat originating from the two heat sources (e.g., the heated build plate 140 and the heat plate 500) separate from the “ambient” air outside of the gas curtain 310.

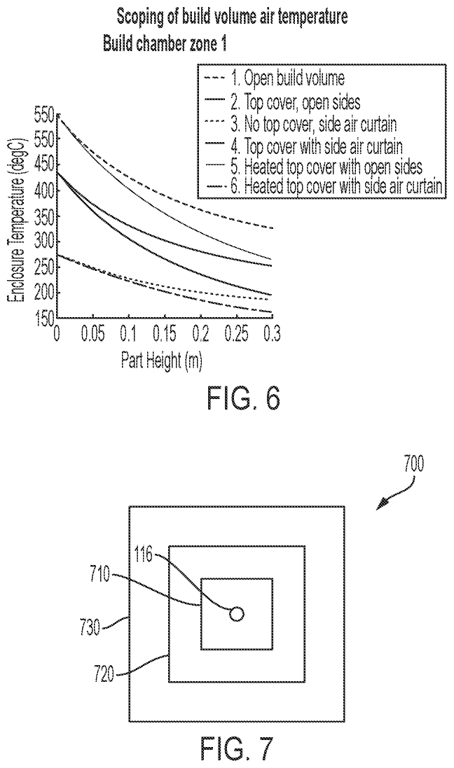

FIG. 6 depicts a graph 600 showing the height of the 3D part 126 versus the temperature inside the gas curtain 310, according to an embodiment. The 3D part 126 in this embodiment is a tensile bar having a horizontal cross-sectional shape of 50 mm×5 mm. The height of the tensile bar is built up to 100 mm. The results in FIG. 6 were generated using a model having the following input parameters:
Build plate temperature: 550° C.
Ambient temperature (e.g., outside of the gas curtain 310): 30° C.
Heat plate temperature: 575° C.
Gas curtain temperature: 100° C.

Various options may be evaluated to increase the build volume temperature inside of the gas curtain 310. In one example, the build volume may be from about 660 mm×660 mm×(H+g), where H is the height of the 3D part 126, and g is the printhead gap between the nozzle 116 and the top surface of the 3D part 126. The model calculations may be for steady state, average temperature at each value of H. More particularly, the energy added from the build plate 140 and/or the heat plate 500 may be balanced with the energy lost through the sides of the gas curtain 310.

FIG. 7 depicts a schematic top view of the build volume 700 (e.g., inside of the gas curtain 310), according to an embodiment. The build volume 700 may be divided into one or more (e.g., three) regions for the model. The first region 710 may be a 100 mm square c/s that is centered around a central longitudinal axis through the nozzle 116. The temperature of the first region 710 may be representative of the temperature around the 3D part 126. The 100 mm area encompassed by the first region 710 may represent the footprint of the 3D part 126 printed by the 3D printer 100, as there is other air volume within the gas curtain 310 that would not be within the footprint of the 3D part 126. The second region 720 may be 100 mm to 330 mm square annulus c/s around the first region 710. The third region 730 may be 330 mm to 660 mm square annulus c/s around the second region 720.

Referring again to FIG. 6, six curves are shown that represent various embodiments within the first region 710 of the build volume 700 from FIG. 7. The first curve 610 represents the height of the 3D part 126 versus the temperature inside the gas curtain 310 when the build volume is open (e.g., no gas curtain 310 and no plate 500). In the first curve 610, the bulk air temperature is low (e.g., 275° C. to start) and then plateaus at about 150° C. The second curve 620 represents the height of the 3D part 126 versus the temperature inside the gas curtain 310 when the plate 500 is present and the gas curtain 310 is not present. The plate 500 is not generating heat in the embodiment of the second curve 620. The third curve 630 represents the height of the 3D part 126 versus the temperature inside the gas curtain 310 when the gas curtain 310 is present and the plate 500 is not present. The fourth curve 640 represents the height of the 3D part 126 versus the temperature inside the gas curtain 310 when the gas curtain 310 and plate 500 are both present. The plate 500 is not generating heat in the embodiment of the fourth curve 640. The fifth curve 650 represents the height of the 3D part 126 versus the temperature inside the gas curtain 310 when the plate 500 is present and the gas curtain 310 is not present. The plate 500 is generating heat in the embodiment of the fifth curve 650. The sixth curve 660 represents the height of the 3D part 126 versus the temperature inside the gas curtain 310 when the gas curtain 310 and the plate 500 are both present. The plate 500 is generating heat in the embodiment of the sixth curve 660. In the sixth curve 660, the starting temperature is very close to 550° C., and as the 3D part 126 is built (e.g., upwards), the temperature drop-off is less dramatic when compared to the other curves. For example, even when the height of the 3D part 126 is 100 mm (0.10 m), the air temperature is still about 450° C.

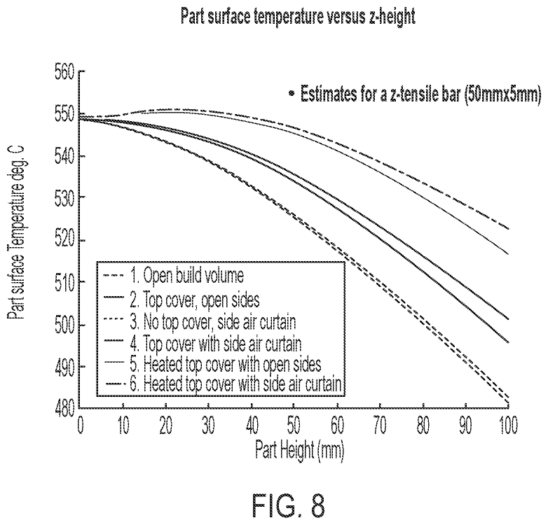

FIG. 8 depicts a graph 800 showing the height of the 3D part 126 versus the temperature of an upper layer (e.g., the top surface) of the 3D part 126, according to an embodiment. The 3D part 126 in FIG. 8 is the same as in FIG. 6 (e.g., the tensile bar). The graph 800 includes six curves: 810, 820, 830, 840, 850, 860 that represent the same six scenarios as in FIG. 6. The temperature in the graph 800 is measured at a particular XY location (e.g., in a horizontal plane) on the top surface of the 3D part 126 after the last drop 124 has landed and solidified at that location, and before the next drop 124 lands at that location (which increases the height in the Z direction). Drops 124 solidify (i.e., also referred to as freezing) in less than or equal to about 5 milliseconds after landing. The time duration between the last drop landing/solidifying and the next drop landing may be from about 2 seconds to about 2 minutes.

As shown in FIG. 8, the sixth curve 860, which represents the height of the 3D part 126 versus the temperature of the (e.g., top) surface of the 3D part 126 when the gas curtain 310 and the heat plate 500 are present, shows the least amount of thermal degradation from the temperature of the build plate 140 (e.g., 550° C.). More particularly, as the 3D part 126 is printed in the embodiment of the sixth curve 860, the temperature of the top surface of the 3D part 126 only drops by about 20° C. up to 100 mm. This performance is on par with a structural enclosure that includes structural (e.g., not gas) walls, such as an “easy-bake” oven.

The benefits of the gas curtain 310 and/or the heat plate 500, as compared to a structural enclosure, are for the most part practical. For instance, a Z-height sensor, which may be located to the side of the build volume may view through areas of glass to see the 3D part 126 in the case of conventional the “easy-bake oven” approach. The ramifications of this for the optics of the Z-height sensor are not trivial. For example, this would require increased design complexity (e.g., more than the complexity because of the air-curtain 310 and/or heat plate 500) to account for the image distortion when looking through glass. This is particularly true when the glass becomes dirty over time, which may require cleaning. In all, the gas curtain 310 and heat plate 500 appear a better option to keep the top surface of the 3D part 126 in the desired temperature range.

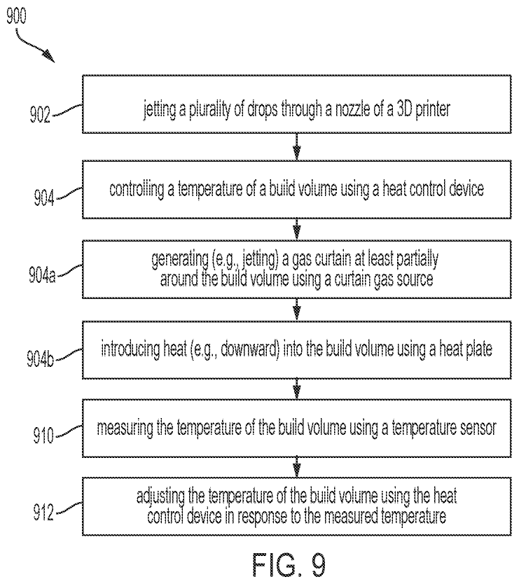

FIG. 9 depicts a flowchart of a method 900 for printing the 3D part 126, according to an embodiment. More particularly, the method 900 may include controlling the temperature within the build volume as the 3D part 126 is printed.

The method 900 is particularly applicable to liquid metal drops 124 in 3D printing applications (as opposed to non-metal drops and/or non 3D printing applications) because of the very steep temperature gradients encountered when jetting liquid metal drops as compared to non-metals (e.g., ink) which melt at much lower temperatures that are much closer to room ambient temperature.

An illustrative order of the method 900 is provided below; however, one or more steps of the method 900 may be performed in a different order, performed simultaneously, combined, split into sub-steps, repeated, or omitted. One or more steps of the method 900 may be performed (e.g., automatically) by the computing system 180.

The method 900 may include jetting a plurality of drops 124 through the nozzle 116 of the 3D printer 100, as at 902. As mentioned above, a first plurality of drops 124 may land on the build plate 140, forming a first layer of the 3D part 126. A second plurality of drops 124 may then land on the first layer, forming a second layer of the 3D part 126, and so on. Each subsequent layer increases the height of the 3D part 126, and thus increases the distance between the (heated) build plate 140 and the upper surface of the 3D part 126.

The method 900 may also include controlling the temperature of the build volume using the heat control device 160, as at 904. This step may take place simultaneously with step 902. Controlling the temperature may include generating (e.g., jetting) the gas curtain 310 at least partially around the build volume using the gas curtain source 300, as at 906. Controlling the temperature may also or instead include introducing heat (e.g., downward) into the build volume using the heat plate 500, as at 908.

The method 900 may also include measuring the temperature of the build volume using a temperature sensor 170, as at 910. The temperature sensor 170 may measure the temperature at one or more locations within the build volume. For example, the temperature sensor 170 may measure the temperature at one or more heights within the build volume. In one embodiment, the temperature sensor 170 may measure the temperature of the gas (e.g., air) within the build volume. In another embodiment, the temperature sensor 170 may measure the temperature of the drops 124 and/or the 3D part 126 within the build volume. For example, the temperature sensor 170 may measure the temperature of the upper surface/layer of the 3D part 126 as the height of the 3D part 126 increases.

The method 900 may also include adjusting the temperature of the build volume using the heat control device 160 in response to the measured temperature, as at 912. This may include adjusting the temperature of the gas curtain 310, the velocity of the gas curtain 310, the direction of the gas curtain 310, or a combination thereof. This may also include adjusting the amount of heat generated by the heat plate 500.

As a result, the method 900 may control the heat control device 160 to prevent the temperature of the (e.g., top surface of the) 3D part 126 from decreasing by more than a predetermined amount as the height of the 3D part 126 (e.g., the distance between the build plate 140 and the top surface of the 3D part 126) increases. For example, the heat control device 160 may prevent the temperature of the top surface from decreasing by more than about 3° C., about 5° C., or about 10° C. as the height increases from about 0 mm (e.g., 1 mm) to about 30 mm. In another example, the heat control device 160 may prevent the temperature of the top surface from decreasing by more than about 10° C., about 15° C., or about 20° C. as the height increases from about 0 mm to about 50 mm. In another example, the heat control device 160 may prevent the temperature of the top surface from decreasing by more than about 25° C., about 40° C., or about 60° C. as the height increases from about 0 mm to about 100 mm.

As a result, the temperature of the (e.g., top surface of the) 3D part 126 may remain within a predetermined range as the height of the 3D part 126 increases. For example, the heat control device 160 may cause the temperature of the top surface of the 3D part 126 to remain within a predetermined range from about 540° C. to about 600° C., about 545° C. to about 600° C., or about 550° C. to about 600° C. as the height increases from about 0 mm to about 30 mm. In another example, the heat control device 160 may cause the temperature of the top surface of the 3D part 126 to remain within a predetermined range from about 530° C. to about 600° C., about 540° C. to about 600° C., or about 545° C. to about 600° C. as the height increases from about 0 mm to about 50 mm. In another example, the heat control device 160 may cause the temperature of the top surface of the 3D part 126 to remain within a predetermined range from about 490° C. to about 600° C., about 510° C. to about 600° C., or about 520° C. to about 600° C. as the height increases from about 0 mm to about 50 mm.

Notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” may include any and all sub-ranges between (and including) the minimum value of zero and the maximum value of 10, that is, any and all sub-ranges having a minimum value of equal to or greater than zero and a maximum value of equal to or less than 10, e.g., 1 to 5.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A printer configured to print a part, the printer comprising:
a heat control device configured to cause a temperature of the part to remain within a predetermined range as a height of the part increases from about 0 mm to about 30 mm, wherein the predetermined range is from about 545° C. to about 600° C., and wherein the heat control device comprises a heat plate that is configured to generate heat in a downward direction toward the part.

2. The printer of claim 1, wherein the temperature is measured on a top surface of the part.

3. The printer of claim 1, wherein the heat control device is also configured to prevent the temperature of the part from decreasing by more than about 5° C. as the height of the part increases from about 0 mm to about 30 mm.

4. The printer of claim 3, wherein the temperature is measured on a top surface of the part.

5. The printer of claim 1, wherein the heat plate is configured to have a temperature from about 375° C. to about 775° C.

6. The printer of claim 1, wherein a distance between the heat plate and the part remains substantially constant the height of the part increases.

7. The printer of claim 1, further comprising a nozzle that is configured to jet a plurality of drops that form the part, wherein a distance between the heat plate and the part is substantially the same as a distance between the nozzle and the part.

8. The printer of claim 1, further comprising a build plate on which the part is printed, wherein a bottom surface of the heat plate is substantially parallel to a top surface of the build plate.

9. The printer of claim 1, wherein the heat control device further comprises a gas curtain source that is configured to generate a gas curtain that at least partially surrounds at least a portion of the part.

10. The printer of claim 9, wherein the gas curtain is directed in a substantially downward direction, and wherein the gas curtain has a temperature from about 40° C. to about 200° C.

11. A 3D printer, comprising:
a pump comprising a nozzle, wherein the nozzle is configured to jet a plurality of drops therethrough, and wherein the drops comprise liquid metal;
a build plate configured to have the drops land thereon and solidify to form a 3D part; and
a heat control device configured to cause a temperature of a top surface of the 3D part to remain within a predetermined range as a distance between the build plate and the top surface of the 3D part increases from about 0 mm to about 50 mm, wherein the predetermined range is from about 530° C. to about 600° C., and wherein the heat control device comprises:
a heat plate positioned above the build plate, wherein the heat plate has an opening through which the nozzle extends, the drops descend, or both, and wherein the heat plate is configured to have a temperature from about 475° C. to about 675° C., which generates heat in a downward direction toward the 3D part.

12. The 3D printer of claim 11, wherein the heat control device is also configured to prevent a temperature of the top surface of the part from decreasing by more than about 20° C. as the distance between the build plate and the top surface of the part increases from about 0 mm to about 50 mm.

13. The 3D printer of claim 11, wherein a distance between the heat plate and the top surface of the 3D part remains constant as the distance between the build plate and the top surface of the 3D part increases, and wherein the distance between the heat plate and the top surface of the 3D part is substantially the same as a distance between the nozzle and the top surface of the 3D part.

14. The 3D printer of claim 11, wherein a bottom surface of the heat plate is substantially parallel to a top surface of the build plate.

15. The 3D printer of claim 11, wherein the heat control device further comprises a gas curtain source that is configured to direct a gas curtain in the downward direction, wherein the gas curtain at least partially surrounds the drops as the drops descend from the nozzle toward the build plate and the 3D part on the build plate, and wherein the gas curtain has a temperature from about 60° C. to about 150° C.

16. A 3D printer, comprising:
a pump comprising a nozzle;
a heating element configured to heat a solid metal within the pump, thereby converting the solid metal to a liquid metal, wherein the solid metal and the liquid metal comprise aluminum;
a coil wrapped at least partially around the pump;
a power source configured to transmit voltage pulses to the coil, wherein the coil causes a plurality of drops of the liquid metal to be jetted through the nozzle in response to the voltage pulses, wherein the drops have a temperature from about 550° C. to about 950° C.;
a shield gas source configured to introduce a shield gas at least partially around the nozzle, the drops, or both;
a build plate configured to have the drops land thereon and solidify to form a 3D part, wherein the build plate comprises a build plate heater that is configured to have a temperature from about 350° C. to about 750° C., which generates heat in an upward direction; and
a heat control device comprising:
a heat plate positioned above the build plate, wherein the heat plate has an opening through which the nozzle extends, the drops descend, or both, wherein the heat plate is configured to have a temperature from about 525° C. to about 625° C., which generates heat in a downward direction toward the 3D part,
wherein the heat control device is configured to:
prevent a temperature of a top surface of the 3D part from decreasing by more than about 60° C. as a distance between the build plate and the top surface of the 3D part increases from about 0 mm to about 100 mm; and
cause the temperature of the top surface of the 3D part to remain within a predetermined range as the distance between the build plate and the top surface of the 3D part increases from about 0 mm to about 100 mm, and wherein the predetermined range is from about 490° C. to about 600° C.

17. The 3D printer of claim 16, wherein a distance between the heat plate and the top surface of the 3D part remains substantially constant as the distance between the build plate and the top surface of the 3D part increases.

18. The 3D printer of claim 16, wherein a distance between the heat plate and the top surface of the 3D part is substantially the same as a distance between the nozzle and the top surface of the 3D part.

19. The 3D printer of claim 16, wherein the build plate further comprises a build plate motor that is configured to move the build plate in a horizontal plane, and wherein the build plate remains below and positioned within a perimeter of the heat plate as the build plate moves in the horizontal plane.

20. The 3D printer of claim 16, wherein the heat control device further comprises a curtain gas source positioned above the build plate, wherein the curtain gas source is configured to direct a gas curtain in a downward direction, wherein the gas curtain comprises an inert gas, wherein the gas curtain at least partially surrounds the drops as the drops descend from the nozzle toward the build plate and the 3D part on the build plate, wherein the gas curtain has a temperature from about 80° C. to about 120° C.
